(19) United States
(12) Patent Application Publication
(10) Pub. No.: US 2026/0088898 A1
(43) Pub. Date: Mar. 26, 2026

(54) OPTICAL TRANSMISSION DEVICE AND OPTICAL TRANSMISSION SYSTEM

(71) Applicant: 1FINITY Inc., Kawasaki-shi (JP)

(72) Inventors: Shota MORI, Yokohama (JP); Yoshito KACHITA, Kawasaki (JP); Yusaku YAMAMOTO, Kawasaki (JP); Takashi SATO, Kawasaki (JP)

(73) Assignee: 1FINITY Inc., Kawasaki-shi (JP)

(21) Appl. No.: 19/328,718

(22) Filed: Sep. 15, 2025

(30) Foreign Application Priority Data
Sep. 20, 2024 (JP) 2024-164089

(51) Int. Cl. H04B 10/077

(52) U.S. Cl. CPC H04B 10/0777

(57) ABSTRACT

An optical transmission device includes a light output unit that outputs OSC (Optical Supervisory Channel) light, a calculator that calculates a tilt amount of a tilt occurring in a pseudo light in an optical transmission line connecting the optical transmission device and another optical transmission device facing the optical transmission device when establishing communication between the optical transmission device and the another optical transmission device based on the OSC light and the pseudo light including a wavelength band of a signal light repeated by the optical transmission device, and a controller that controls output of the pseudo light based on the tilt amount.

### CROSS-REFERENCE TO RELATED APPLICATION

This application is based upon and claims the benefit of priority of Japanese Patent Application No. 2024-164089 filed on Sep. 20, 2024, the entire contents of which are incorporated herein by reference.

### FIELD

A certain aspect of the present embodiments described herein relates to an optical transmission device and an optical transmission system.

### BACKGROUND

There is known an optical transmission system for transmitting a WDM (Wavelength Division Multiplexing) signal light including a plurality of optical signals having different wavelengths. There is also known an optical transmission system in which a signal light is amplified by an optical repeater using an optical amplifier and the amplified signal light is repeated and transmitted (see, for example, Japanese Patent Application Laid-Open No. 2003-124889).

An optical transmission system includes an optical transmitter and an optical receiver. The optical transmitter and the optical receiver have the same function as each other in reality. For example, an optical transmitter is provided with an optical amplifier for amplifying and outputting signal light. In addition, in the optical transmission system, an optical supervisory signal called an OSC (Optical Supervisory Channel) is used for operation setting, state monitoring, and the like (see, for example, Japanese Laid-Open Patent Application No. 2003-124889 and 2004-088376, U.S. Pat. No. 10,992,374, or U.S. Patent Application Publication No. 2006/0140626).

### SUMMARY

In one embodiment, there is provided an optical transmission device including a light output unit that outputs OSC (Optical Supervisory Channel) light, a calculator that calculates a tilt amount of a tilt occurring in a pseudo light in an optical transmission line connecting the optical transmission device and another optical transmission device facing the optical transmission device when establishing communication between the optical transmission device and the another optical transmission device based on the OSC light and the pseudo light including a wavelength band of a signal light repeated by the optical transmission device, and a controller that controls output of the pseudo light based on the tilt amount.

The object and advantages of the invention will be realized and attained by option of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is an example of an optical transmission system according to a first embodiment.

FIG. 2 is another example of the optical transmission system according to the first embodiment.

FIG. 3 is a flowchart showing an example of the operation of an optical transceiver according to the first embodiment.

FIG. 4 is a flowchart showing an example of the operation of the optical transmission device according to the first embodiment.

FIG. 5A is a diagram for explaining a comparative example according to the first embodiment, and FIG. 5B is a diagram for explaining an example of the first embodiment.

FIG. 6A is a diagram for explaining another comparative example related to the first embodiment, and FIG. 6B is a diagram for explaining another example according to the first embodiment.

FIG. 7A is a diagram for explaining a comparative example related to a second embodiment, and FIG. 7B is a diagram for explaining an example of the second embodiment.

FIG. 8A is a diagram for explaining a comparative example related to a third embodiment, and FIG. 8B is a diagram for explaining an example of the third embodiment.

FIG. 9 is an example of an optical transmission system according to a fourth embodiment.

FIG. 10 is a flowchart showing an example of the operation of an optical transmission device according to the fourth embodiment.

FIG. 11A is a diagram for explaining a comparative example related to the fourth embodiment, and FIG. 11B is a diagram for explaining an example of the fourth embodiment.

FIG. 12 is an example of an optical transmission system according to a fifth embodiment.

FIG. 13 is a flowchart showing an example of the operation of the optical transmission device according to the fifth embodiment.

### DETAILED DESCRIPTION

A plurality of stages of optical transmission devices may be interposed between the optical transmitter and the optical receiver as optical repeaters. In some optical transmission lines between optical transmission devices, since the span loss indicating the loss value of the optical transmission line is excessive, it may be difficult to transmit the OSC light between the optical transmission devices with the optical power of the above-described optical monitoring signal (hereinafter referred to as the OSC light). In this case, there is a possibility that the optical transmission device cannot confirm the communication of the OSC light when the optical transmission device is started.

When the optical transmission device cannot confirm the communication of the OSC light, for example, an increase in the optical power of the OSC light using a pseudo light called a pseudo wave is assumed. The pseudo light is output from the optical transmitter and is repeated to reach the optical transmitter, which cannot confirm the communication of the OSC light. The pseudo light propagates through a plurality of optical transmission lines from the optical transmitter to the optical transmission device.

However, when the pseudo light propagates in the optical transmission line in multiple stages, the pseudo light is tilted every time it propagates in the optical transmission line. The tilt generated in the pseudo light is caused by stimulated Raman scattering, wavelength dependent loss, and the like. Therefore, the tilt amount of the pseudo light cumulatively increases until the pseudo light reaches the optical transmission device. As a result, the optical power is unevenly distributed on the long wavelength side of the pseudo light. Since the wavelength of the OSC light is near the long wavelength side of the longest wavelength of the pseudo light, if the optical power is unevenly distributed on the long wavelength side of the pseudo light, the gain from the pseudo light to the OSC light is insufficient, and the increase of the optical power of the OSC light may become insufficient. If the optical power of the OSC light is insufficient, the optical transmission device may fail to confirm the communication of the OSC light.

Hereinafter, embodiments will be described with reference to the drawings.

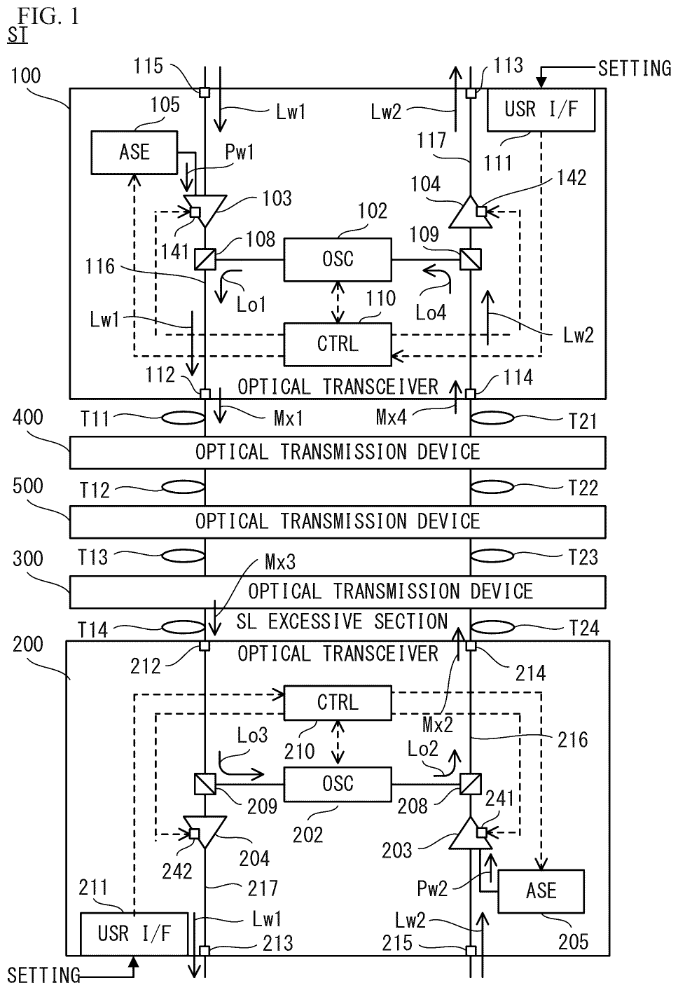

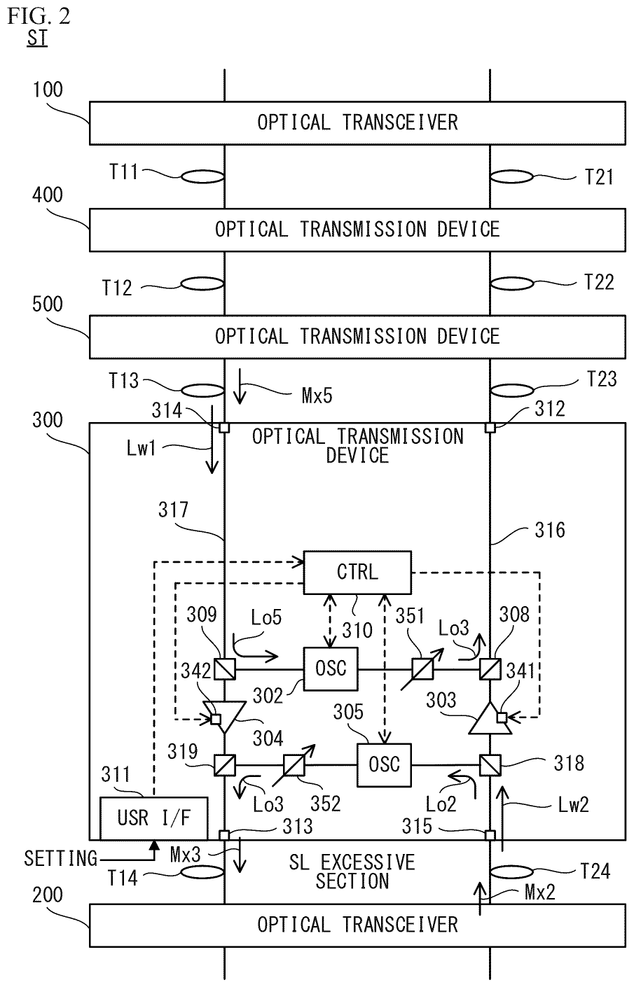

(First Embodiment) As shown in FIGS. 1 and 2, an optical transmission system ST includes two optical transceivers 100 and 200, which are indirectly opposed to each other. A plurality of optical transmission devices 300, 400 and 500 directly opposed to each other are interposed between the optical transceivers 100 and 200. Each of the optical transceivers 100 and 200 includes, for example, a reconfigurable optical add/drop multiplexer (ROADM). Each of the optical transmission devices 300, 400 and 500 includes, for example, an ILA (In-Line Amplifier). Each of the optical transmission devices 300, 400 and 500 can repeat WDM signal lights Lw1 and Lw2 transmitted from the optical transceivers 100 and 200. Thus, each of the optical transceivers 100 and 200 can receive the WDM signal light Lw1 and the WDM signal light Lw2. In the first embodiment, the optical transmission device 300 is described as an example of an optical transmission device, and the optical transceiver 200 is described as an example of another optical transmission device.

The optical transceiver 100 is connected to the optical transmission device 400 via two optical transmission lines T11 and T21 arranged in parallel. The optical transceiver 200 is connected to the optical transmission device 300 via two optical transmission lines T14 and T24 arranged in parallel. The optical transmission device 500 is connected to the optical transmission device 400 via two optical transmission lines T12 and T22 arranged in parallel. The optical transmission device 500 is connected to the optical transmission device 300 via two optical transmission lines T13 and T23 arranged in parallel. The optical transmission lines T11, T12, T13, T14, T21, T22, T23, and T24 all include optical fibers. The type of the optical fibers is not particularly limited. For example, the optical fibers may be an SMF (Single Mode Fiber) or a DSF (Dispersion Shifted Fiber).

First, the optical transceiver 100 will be described with reference to FIG. 1. The optical transceiver 100 includes an OSC input/output unit 102, optical amplifiers 103 and 104, and an amplified spontaneous emission (ASE) light source 105. The optical transceiver 100 includes a WDM coupler 108, a branch coupler 109, and a controller (denoted as CTRL in FIG. 1) 110. The branch coupler 109 may be a WDM coupler.

The optical transceiver 100 further includes a user interface (denoted as USR I/F in FIG. 1) 111, optical transmission units 112 and 113, and optical reception units 114 and 115. Each of the optical transmission units 112 and 113 and the optical reception units 114 and 115 includes a respective connector. The optical amplifier 103, the WDM coupler 108, the optical transmission unit 112, and the optical reception unit 115 are provided on an optical path 116 of the optical transceiver 100. The optical amplifier 104, the branch coupler 109, the optical transmission unit 113, and the optical reception unit 114 are provided on an optical path 117 of the optical transceiver 100. The optical paths 116 and 117 may be optical fibers. The OSC input/output unit 102 is optically connected to the WDM coupler 108 and

the branch coupler 109. The OSC input/output unit 102 outputs an OSC light Lo1 directed to the optical transmission device 400. The OSC light Lo1 may or may not include a span loss of the optical transmission line T21. The OSC input/output unit 102 receives an OSC light Lo4 output from the optical transmission device 400. The OSC light Lo4 may or may not include a span loss of the optical transmission line T11.

The optical amplifier 103 amplifies and outputs the WDM signal light Lw1 received by the optical transceiver 100 via the optical reception unit 115 and a pseudo light Pw1 described later. That is, the optical amplifier 103 increases the optical power of the WDM signal light Lw1 and the pseudo light Pw1 and outputs the increased optical power. The optical amplifier 103 is a post-amplifier including, for example, an EDFA (Erbium Doped Fiber Amplifier). The optical amplifier 103 is provided with a circuit board 141 for controlling the gain of the optical amplifier 103.

The post-amplifier is an amplifier provided in the subsequent stage or downstream of a WSS (Wavelength Selective Switch) (not shown) provided between the optical amplifier 103 and the ASE light source 105. The WDM signal light Lw1 output from the optical amplifier 103 is transmitted to the optical transmission line T11 via the optical transmission unit 112.

The optical amplifier 104 amplifies and outputs the WDM signal light Lw2 received by the optical transceiver 100 via the optical reception unit 114 and a pseudo light Pw2 described later. The optical amplifier 104 is a preamplifier including, for example, an EDFA. The optical amplifier 104 is provided with a circuit board 142 for controlling the gain of the optical amplifier 104. The preamplifier is an amplifier provided in the front stage or upstream of a WSS (not shown) provided between the optical amplifier 104 and the optical transmission unit 113. The WDM signal light Lw2 output from the optical amplifier 104 is transmitted through the optical transmission unit 113.

The ASE light source 105 is optically connected to the optical amplifier 103. More specifically, the ASE light source 105 is indirectly connected to the optical amplifier 103 through the WSS described above. The ASE light source 105 outputs the pseudo light Pw1 called a pseudo wave, for example. The pseudo light Pw1 includes a wavelength band of the WDM signal light Lw1, such as a C-band (Conventional-band) or an L-band (Long-wavelength-band). It is noted that the C band is a wavelength band of, for example, 1530 nm to 1565 nm. The L band is a wavelength band of, for example, 1565 nm to 1625 nm.

The pseudo light Pw1 is amplified by the optical amplifier 103. After amplification, the pseudo light Pw1 is multiplexed with the OSC light Lo1 by the WDM coupler 108. Thus, multiplexed light Mx1 is generated by multiplexing the OSC light Lo1 and the pseudo light Pw1. The optical transmission unit 112 transmits the multiplexed light Mx1 to the optical transceiver 200. Thus, the multiplexed light Mx1 propagates through the optical transmission line T11.

The controller 110 is electrically connected to the OSC input/output unit 102, the circuit boards 141 and 142 of the optical amplifiers 103 and 104, the ASE light source 105, and the user interface 111. The controller 110 includes a processor such as a CPU (Central Processing Unit) and a memory such as a RAM (Random Access Memory) or a ROM (Read Only Memory). The controller 110 may include a field programmable gate array (FPGA) or an application specific integrated circuit (ASIC).

The controller 110 controls the operation of the OSC input/output unit 102, the optical amplifiers 103 and 104, and the ASE light source 105. For example, the controller 110 can request the OSC input/output unit 102 to output the OSC light Lo1. The controller 110 can request the ASE light source 105 to output the pseudo light Pw1. The controller 110 can adjust the gain of the optical amplifiers 103 and 104 through the circuit boards 141 and 142.

When the optical transceiver 100 starts to operate before the optical transmission system ST starts to operate, the controller 110 acquires, from the user interface 111, setting information including, for example, the span loss of the optical transmission line T11 as the own line. That is, the controller 110 acquires the setting information before the communication between the WDM signal lights Lw1 and Lw2 is started. When the controller 110 determines that the span loss is excessive based on the setting information, the controller 110 switches the start mode based on the setting of the start mode from the user via the user interface 111.

Specifically, the controller 110 determines that the span loss is excessive when the span loss is equal to or greater than a predetermined value to be compared. When the span loss is too large, the controller 110 switches the mode from a normal mode in which the pseudo light Pw1 is not output to an extended mode in which the pseudo light Pw1 is output.

Next, the optical transceiver 200 will be described. The optical transceiver 200 includes an OSC input/output unit 202 and optical amplifiers 203 and 204. The optical amplifiers 203 and 204 are provided with circuit boards 241 and 242, respectively. The optical transceiver 200 includes an ASE light source 205, a WDM coupler 208, a branch coupler 209, and a controller 210. The optical transceiver 200 further includes a user interface 211, optical transmission units 213 and 214, and optical reception units 212 and 215.

The optical amplifier 203, the WDM coupler 208, the optical transmission unit 214, and the optical reception unit 215 are provided on an optical path 216 of the optical transceiver 200. The optical amplifier 204, the branch coupler 209, the optical transmission unit 213, and the optical reception unit 212 are provided on an optical path 217 of the optical transceiver 200.

As described above, the optical transceiver 200 basically has a configuration similar to the optical transceiver 100. Therefore, the details of the optical transceiver 200 are omitted. For example, the OSC input/output unit 202 outputs an OSC light Lo2 directed to the optical transmission device 300. The ASE light source 205 outputs the pseudo light Pw2 including the wavelength band of the WDM signal light Lw2, such as the C-band or the L-band. The optical transmission unit 214 transmits the multiplexed light Mx2 obtained by multiplexing the OSC light Lo2 and the pseudo light Pw2 to the optical transceiver 100. Thus, the multiplexed light Mx2 propagates through the optical transmission line T24.

Next, the optical transmission device 300 will be described with reference to FIG. 2. The optical transmission devices 400 and 500 have basically a configuration similar to the optical transmission device 300, and therefore, a detailed description thereof will be omitted.

The optical transmission device 300 includes an OSC input/output unit 302, optical amplifiers 303 and 304, and an OSC input/output unit 305. The OSC input/output units 302 and 305 are examples of optical output units. The optical amplifiers 303 and 304 are provided with circuit boards 341 and 342, respectively. The circuit boards 341 and 342 are examples of controllers that control the output of the pseudo light beams Pw1 and Pw2. The optical amplifiers 303 and 304 may be an example of the controller.

The optical transmission device 300 includes a WDM coupler 308, a branch coupler 309, a controller 310, a branch coupler 318, and a WDM coupler 319. The controller 310 is an example of a calculator that calculates the tilt amount of the tilt occurring in the pseudo light Pw1 and the pseudo light Pw2.

The optical transmission device 300 further includes a user interface 311, optical transmission units 312 and 313, optical reception units 314 and 315, and variable optical attenuators (VOAs) 351 and 352. In contrast, the optical transmission device 300 does not include an ASE light source. That is, the ASE light source is excluded from the optical transmission device 300. Therefore, the optical transmission device 300 cannot emit the pseudo lights Pw1 and Pw2.

The optical amplifier 303, the WDM coupler 308, the optical transmission unit 312, the optical reception unit 315, and the branch coupler 318 are provided on an optical path 316 of the optical transmission device 300. The optical amplifier 304, the WDM coupler 319, the branch coupler 309, the optical transmission unit 313, and the optical reception unit 314 are provided on an optical path 317 of the optical transmission device 300.

The OSC input/output unit 302 is optically connected to the WDM coupler 308 and the branch coupler 309. The OSC input/output unit 302 outputs an OSC light Lo3 to the optical transmission device 500. The OSC light Lo3 may or may not include the span loss of the optical transmission line T13. An OSC light Lo5 output from the optical transmission device 500 is input to the OSC input/output unit 302. The OSC light Lo5 may or may not include the span loss of the optical transmission line T23.

The OSC input/output unit 305 is optically connected to the WDM coupler 319 and the branch coupler 318. The OSC input/output unit 305 outputs the OSC light Lo3 to the optical transceiver 200. The OSC light Lo3 may or may not include the span loss of the optical transmission line T24. The OSC input/output unit 305 receives the OSC light Lo2 output from the optical transceiver 200. The OSC light Lo2 may or may not include the span loss of the optical transmission line T14.

The optical amplifier 303 amplifies and outputs the WDM signal light Lw2 received by the optical transmission device 300 via the optical reception unit 315 and the pseudo light Pw2 belonging to the multiplexed light Mx2. That is, the optical amplifier 303 increases the optical power of the WDM signal light Lw2 and the pseudo light Pw2 and outputs the increased optical power. The optical amplifier 303 is an amplifier including, for example, an EDFA. The optical amplifier 303 is provided with the circuit board 341 for controlling and adjusting the gain of the optical amplifier 303. The WDM signal light Lw2 output from the optical amplifier 303 is transmitted to the optical transmission line T23 via the optical transmission unit 312.

The optical amplifier 304 amplifies and outputs the WDM signal light Lw1 received by the optical transmission device 300 via the optical reception unit 314 and the pseudo light Pw1 belonging to the multiplexed light Mx5. That is, the optical amplifier 304 increases the optical power of the WDM signal light Lw1 and the pseudo light Pw1 and outputs the increased optical power. The optical amplifier 304 is an amplifier including, for example, an EDFA. The optical amplifier 304 is provided with the circuit board 342 for controlling and adjusting the gain of the optical amplifier 304. The WDM signal light Lw1 output from the optical amplifier 304 is transmitted through the optical transmission unit 313.

The controller 310 is electrically connected to the OSC input/output units 302 and 305, the circuit boards 341 and 342 of the optical amplifiers 303 and 304, and the user interface 311. Although not shown, the controller 310 is also electrically connected to the VOAs 351 and 352. The hardware configuration of the controller 310 is basically similar to that of the controller 110, and therefore, a detailed description thereof will be omitted. The controller 310 controls the operations of the OSC input/output units 302 and 305, the circuit boards 341 and 342 of the optical amplifiers 303 and 304, and the VOAs 351 and 352.

For example, the controller 310 can individually request the OSC input/output units 302 and 305 to output the OSC lights Lo3. The controller 310 can adjust the gain of the optical amplifiers 303 and 304 through the circuit boards 341 and 342, respectively. The controller 310 can adjust the attenuation of the VOAs 351 and 352.

The controller 310 acquires setting information including the span loss of the optical transmission lines T13, T14, T23, and T24, for example, from the user interface 311 at the start of the activation of the optical transmission device 300 before the operation of the optical transmission system ST is started. That is, the controller 310 acquires the setting information before the start of the communication of the WDM signal lights Lw1 and Lw2. When the controller 310 determines that the span loss is excessive in any of the optical transmission lines T11, . . . , T24 based on the setting information, a controller 110 switches the start mode based on the setting of the start mode from the user via the user interface 311.

Specifically, the controller 310 determines that the span loss is excessive when the span loss is equal to or greater than a predetermined value to be compared. When the span loss is excessive, the controller 310 switches from a normal mode in which tilt control is not executed for the pseudo light beams Pw1 and Pw2 to an extended mode in which tilt control is executed.

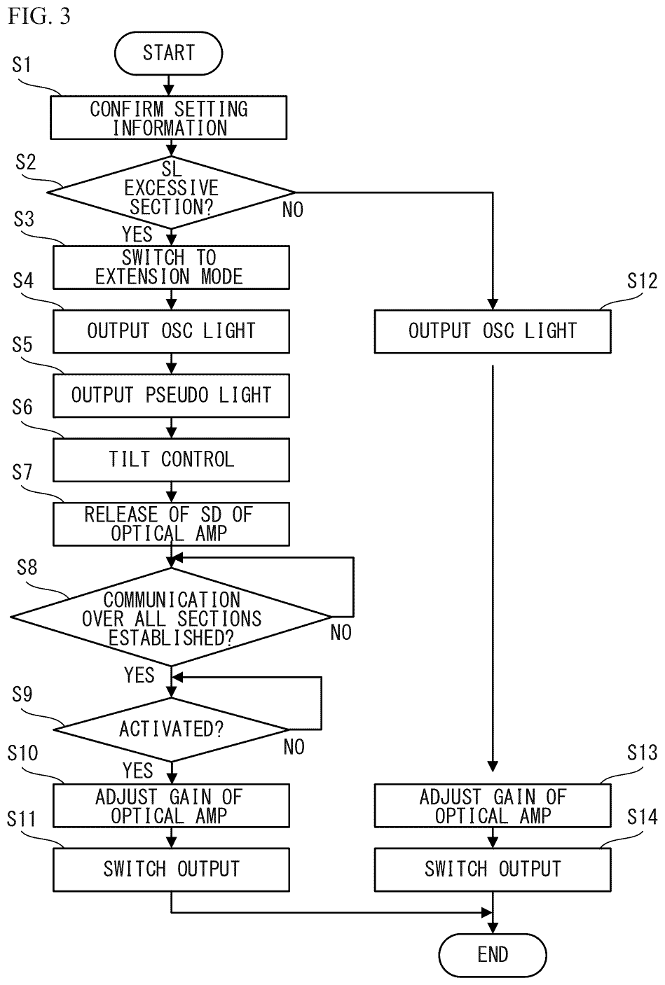

Referring to FIG. 3, the operation of the optical transceiver 100 according to the first embodiment will be described. The controllers 110 and 210 basically execute the same processing. Therefore, the processing executed by the controller 110 will be described as an example, and the processing executed by the controller 210 will be omitted.

When the user provides the optical transceiver 100 with predetermined setting information, the controller 110 acquires and checks the setting information (step S1). The setting information includes, for example, the span loss of the optical transmission line T11, the transmission line length of the optical transmission line T11, and the like. As will be described later, before the processing of step S1, the controller 110 may measure the span loss of the optical transmission line T1 based on the optical power of the optical light output from the optical transceiver 100 to the optical transmission line T1 and the optical power of the reflected light. The span loss may be prepared in advance. When the setting information is confirmed, the controller 110 determines whether or not the optical transmission line T11 is a span loss excessive section (represented as an SL excessive section in FIG. 3) based on the setting information (step S2).

When the optical transmission line T11 is in the span loss excessive section (step S2: YES), the controller 110 switches the start mode to the extension mode based on the setting of the start mode from the user (step S3). When the mode is switched to the extension mode, the controller 110 requests the OSC input/output unit 102 to output the OSC light Lo1 (step S4).

Thus, the OSC input/output unit 102 outputs the OSC light Lo1 with a predetermined optical power level of a few dBm (see FIG. 1). However, the optical transmission line T11 corresponds to the span loss excessive section. Therefore, even if the OSC light Lo1 is output, the OSC light Lo1 cannot reach the optical transmission device 400 by itself due to the shortage of the optical power.

Therefore, when the OSC light Lo1 is output, the controller 110 requests the output of the pseudo light Pw1 as shown in FIG. 3 (step S5). More specifically, the controller 110 determines a constant optical power to be used for outputting the pseudo light Pw1 based on the type of the optical transmission line T11, and requests the output of the pseudo light Pw1 based on the constant optical power. As a result, the ASE light source 105 outputs the pseudo light Pw1 with the constant optical power determined by the controller 110 (see FIG. 1).

When the pseudo light Pw1 is output, the controller 110 executes a tilt control (step S6). For example, the controller 110 calculates the tilt amount of the tilt (hereinafter referred to as a transmission line tilt) occurring in the pseudo light Pw1 in the optical transmission line T11 which is the transmitter side of the optical transceiver 100. The method by which the controller 110 calculates the tilt amount of the transmission line tilt will be described later.

When the tilt amount is calculated, the controller 110 generates a reverse tilt, which flattens the tilt generated in the pseudo light Pw1 in the optical transmission line T11, on the basis of the tilt amount, and requests the circuit board 141 of the optical amplifier 103 to perform control to apply the reverse tilt to the pseudo light Pw1 as tilt control.

When the tilt control is executed, the controller 110 requests the optical amplifier 103 to release the shutdown (indicated as SD in FIG. 3) (step S7). That is, the controller 110 forcibly starts the optical amplifier 103. As a result, the optical amplifier 103 allows the pseudo light Pw1 to pass through. Thus, the pseudo light Pw1 is amplified by the optical amplifier 103, and the optical power of the pseudo light Pw1 is increased. Here, the circuit board 141 of the optical amplifier 103 is requested to perform the tilt control by the controller 110. Therefore, the optical amplifier 103 applies a reverse tilt to the pseudo light Pw1.

As a result, the optical amplifier 103 outputs the pseudo light Pw1 to which the reverse tilt is applied. Thus, the multiplexed light Mx1 is generated by multiplexing the OSC light Lo1 and the pseudo light Pw1 to which the reverse tilt is applied. The multiplexed light Mx1 is output from the optical transceiver 100 to the optical transmission device 400 and propagates along the optical transmission line T11 (see FIG. 1).

When the shutdown of the optical amplifier 103 is released, the controller 110 waits until the OSC lights Lo1, . . . , Lo5 are communicated in all sections from the optical transceiver 100 to the optical transceiver 200 (step S8: NO). When the communication of the OSC lights Lo1, . . . , Lo5 is ensured (step S8: YES), the controller 110 stands by until the own line rises (step S9: NO).

That is, when the pseudo light Pw1 is output, the optical power of the OSC light Lo1 is increased in the optical transmission line T11. Although the details will be described later, since the wavelength of the OSC light Lo1 is longer than that of the pseudo light Pw1, when the multiplexed light Mx1 propagates through the optical transmission line T11, stimulated Raman scattering occurs, and the optical power of the pseudo light Pw1 included in the multiplexed light Mx1 transits to the OSC light Lo1. As a result, the optical power of the OSC light Lo1 is improved. Thus, even if the optical transmission line T11 is in the span loss excessive section, the communication of the OSC light Lo1 between the optical transceiver 100 and the optical transmission device 400 is ensured, and the OSC light Lo1 can reach the optical transmission device 400 from the optical transceiver 100.

However, for example, when the optical transmission line T14 is in the span loss excessive section, if a great tilt is accumulated in the pseudo light Pw1 reaching the optical transmission device 400 by the repeat of the optical transmission device 300, the gain of the pseudo light Pw1 with respect to the OSC light Lo3 becomes insufficient. This makes it difficult to increase the optical power of the OSC light Lo3, and the communication of the OSC light Lo3 between the optical transmission device 300 and the optical transceiver 200 is interrupted. Therefore, the controller 110 waits until the communication of the OSC lights Lo1, . . . , Lo5 is ensured in the entire section from the optical transceiver 100 to the optical transceiver 200.

When the communication of the OSC lights Lo1, . . . , Lo5 is ensured in all the sections, the controller 110 stands by until the own line is activated. That is, the controller 110 waits until the optical transmission line T11, which is the own line, rises. When the line under the controller 110 is activated (step S9: YES), the controller 110 adjusts the gains of the optical amplifiers 103 and 104 (step S10). More specifically, the controller 110 adjusts the gains of the optical amplifiers 103 and 104 based on the span loss of the optical transmission lines T11 and T21.

Thus, the optical amplifiers 103 and 104 are adjusted to have gains suitable for transmission of the WDM signal lights Lw1 and Lw2, respectively. The controller 110 can measure the span loss of the optical transmission line T11 based on the optical power of the optical light output from the optical transceiver 100 to the optical transmission line T11 and the optical power of the reflected light.

After the gains of the optical amplifiers 103 and 104 are adjusted, the controller 110 switches the output from the optical transceiver 100 (step S11), and the process ends. Specifically, the controller 110 stops the output of the pseudo light Pw1, switches the output of the multiplexed light Mx1 to the output of the WDM signal light Lw1, and ends the processing.

On the other hand, in the processing of step S2, when the optical transmission line T11 is not in the span loss excessive section (step S2: NO), the controller 110 requests the OSC input/output unit 102 to output the OSC light Lo1 (step S12). When the span loss is not excessive, the OSC input/output unit 102 may output the OSC light Lo1 at the above-described constant optical power or at an optical power lower than the constant optical power. Since the span loss is not excessive, the OSC light Lo1 can reach the optical transmission device 400 from the optical transceiver 100.

When the OSC light Lo1 is output, the controller 110 adjusts the gains of the optical amplifiers 103 and 104 (step S13). More specifically, the controller 110 adjusts the gains of the optical amplifiers 103 and 104 based on the span loss of the optical transmission lines T11 and T12. Thus, the optical amplifiers 103 and 104 are adjusted to have gains suitable for transmission of the WDM signal lights Lw1 and Lw2, respectively. The controller 110 can measure the span loss of the optical transmission line T11 based on the attenuation amount of the optical power of the OSC light Lo1 output from the optical transceiver 100 to the optical transmission line T11. The attenuation amount of the optical power of the OSC light Lo1 is notified to the optical transceiver 100 via the OSC light Lo4 output from the optical transmission device 400.

After the gain of the optical amplifiers 103 and 104 is adjusted, the controller 110 switches the output from the optical transceiver 100 (step S14) and ends the processing. Specifically, the controller 110 switches the output of the OSC light Lo1 to the output of the WDM signal light Lw1, and ends the processing.

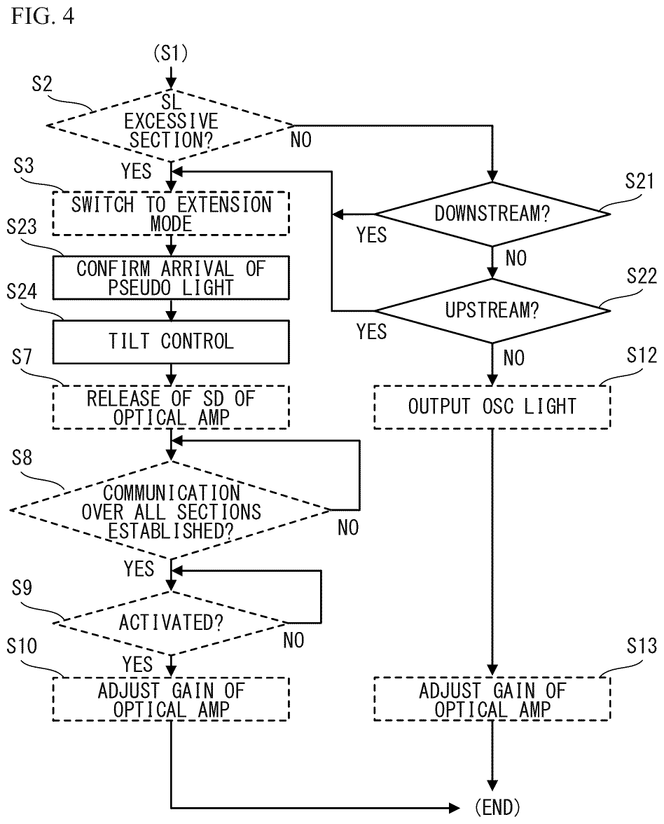

Referring to FIG. 4, the operation of the optical transmission device 300 will be described. The operations of the optical transmission devices 400 and 500 are basically similar to that of the optical transmission device 300, and therefore, a detailed description thereof will be omitted. The same operation as that of the optical transceiver 100 described above is basically denoted by the same reference numeral, and a detailed description thereof will be omitted.

Similarly to the processing of the above-described step S2, when the optical transmission lines T13, T14, T23, and T24 are not the span loss excessive sections, the controller 310 determines whether or not there is a span loss excessive section downstream of the optical transmission device 300 (step S21). If there is no span loss excessive section (step S21: NO), the controller 310 determines whether or not there is a span loss excessive section upstream of the optical transmission device 300 (step S22). If there is no span loss excessive section (step S22: NO), the controller 310 executes the processing of steps S12 and S13, and ends the processing. The controller 310 can determine whether or not there is a span loss excessive section in the downstream or upstream of the optical transmission device 300 based on predetermined information transferred from the optical transceiver 200, the optical transmission device 400, and the like.

On the other hand, when there is a span loss excessive section (step S21: YES, step S22: YES), the controller 310 executes the processing of step S3, and then confirms the arrival of the pseudo light (step S23). Specifically, the controller 310 confirms the arrival of the pseudo light Pw1 output from the optical transmission device 500. When the controller 310 confirms the arrival of the pseudo light Pw1, the controller determines a constant optical power to be used for outputting the pseudo light Pw1 based on the type of the optical transmission line T14, and requests the circuit board 342 of the optical amplifier 304 to output the pseudo light Pw1 based on the constant optical power. As a result, the circuit board 342 can control the optical power of the pseudo light Pw1 to the constant optical power determined by the controller 310. When the optical power of the pseudo light Pw1 is controlled, the controller 310 executes a tilt control (step S24).

For example, the controller 310 calculates the amount of the transmission line tilt that occurs in the pseudo light Pw1 in the optical transmission line T14 that is the transmitter side of the optical transmission device 300. More specifically, the controller 310 individually calculates the tilt amount of SRS (Stimulated Raman Scattering) tilt due to SRS and the tilt amount of WDL (Wavelength Dependent Loss) caused by wavelength dependent loss, and calculates the total of the two tilt amounts as the tilt amount of the transmission line tilt. The SRS tilt is an example of a first tilt, and the WDL tilt is an example of a second tilt.

The controller 310 can calculate the tilt amount of the SRS tilt based on at least one of the type of the optical transmission line T14 (specifically, an optical fiber), the output power for outputting the pseudo light Pw1 to the optical transmission line T14, the loss coefficient according to the type of the optical transmission line T14, and the connection loss between the optical transmission line T14 and the optical transmission device 300, and a known first calculation formula specified in advance. The tilt amount of the SRS tilt is an example of a first tilt amount.

The controller 310 can calculate the transmission line distance of the optical transmission line T14 based on the transmission line loss of the optical transmission line T14 and the loss coefficient corresponding to the type of the optical transmission line T14. The controller 310 can calculate the tilt amount of the WDL tilt based on the calculated transmission line distance, the loss value per unit distance of the WDL, and the known second calculation formula designated in advance. The tilt amount of the WDL tilt is an example of the second tilt amount.

The controller 110 can calculate the tilt amounts of the SRS tilt and the WDL tilt, and sum up the two tilt amounts to calculate the tilt amount of the transmission line tilt, as in the case of the controller 310. When the amount of tilt in the transmission line tilt is calculated, the controller 310 generates a reverse tilt, which flattens the tilt occurring in the pseudo light Pw1 in the optical transmission line T14, based on the amount of tilt, and requests the circuit board 342 of the optical amplifier 304 to perform control to apply the reverse tilt to the pseudo light Pw1 as tilt control. After the tilt control is executed, the controller 310 executes the subsequent steps S7 to S10 and ends the processing.

Thus, the pseudo light Pw1 is amplified by the optical amplifier 103, and the optical power of the pseudo light Pw1 is increased. Here, the circuit board 342 of the optical amplifier 304 is requested to perform the tilt control by the controller 310. Therefore, the optical amplifier 304 applies the reverse tilt to the pseudo light Pw1. As a result, the optical amplifier 304 outputs the pseudo-light Pw1 to which the reverse tilt is applied. Thus, the multiplexed light Mx3 is generated by multiplexing the OSC light Lo3 and the pseudo light Pw1 to which the reverse tilt is applied. The multiplexed light Mx3 is output from the optical transmission device 300 toward the optical transceiver 200 and propagates along the optical transmission line T14 (see FIG. 2).

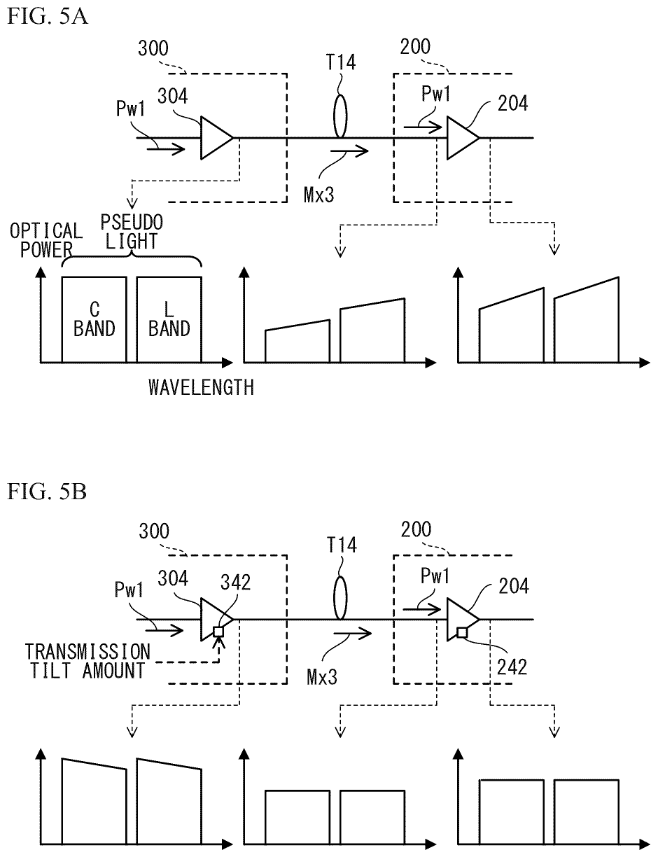

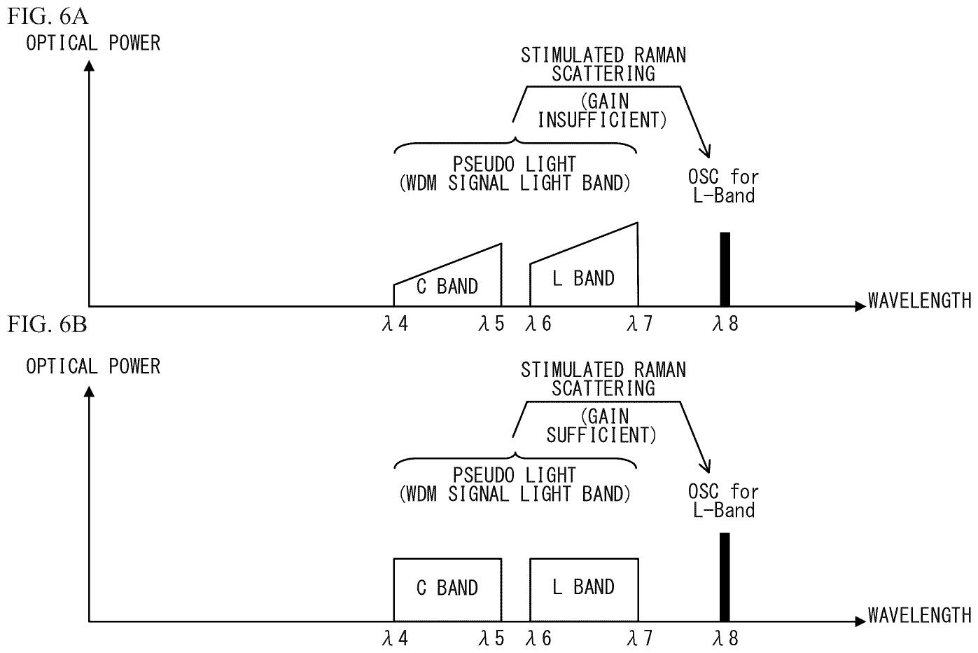

Referring to FIGS. 5A and 5B and FIGS. 6A and 6B, an example of the first embodiment will be described in comparison with a comparative example related to the first embodiment.

First, in the case of the comparative example in which the tilt control is not executed, as shown in FIG. 5A, the optical amplifier 304 can output the pseudo light Pw1 having a flat optical power without tilt. Thus, the multiplexed light Mx3 including the pseudo light Pw1 is output from the optical transmission device 300 and propagates through the optical transmission line T14.

However, when the pseudo light Pw1 propagates through the optical transmission line T14, a tilt occurs in the pseudo light Pw1. As a result, as shown in FIG. 6A, the gain from the pseudo light Pw1 with respect to the OSC light Lo3 included in the multiplexed light Mx3 becomes insufficient, and it becomes difficult to increase the optical power of the OSC light Lo3. Since the pseudo light Pw1 has a tilt in the optical transmission line T14, the pseudo light Pw1 branched from the multiplexed light Mx3 by the optical transceiver 200 is input to the optical amplifier 204 in a state where the tilt remains, as shown in FIG. 5A. Therefore, even if the pseudo light Pw1 is amplified by the optical amplifier 204, the tilt remains in the pseudo light Pw1.

In contrast, in the case of the embodiment in which the tilt control is executed, as shown in FIG. 5B, the optical amplifier 304 can output the pseudo light Pw1 to which the reverse tilt is given based on the transmission line tilt amount. The transmission line tilt amount represents the tilt amount of the transmission line tilt. Thus, the multiplexed light Mx3 including the pseudo light Pw1 whose optical power is higher on the short wavelength side than that on the long wavelength side is output from the optical transmission device 300 and propagates through the optical transmission line T14.

When propagating through the optical transmission line T14, the pseudo light Pw1 is tilted. Since the pseudo-light Pw1 is given the reverse tilt, when the pseudo-light Pw1 is tilted, the tilt is offset by the reverse tilt, and as shown in FIG. 6B, the pseudo-light Pw1 having a flat optical power with the tilt suppressed is generated. Thus, the gain from the pseudo light Pw1 with respect to the OSC light Lo3 included in the multiplexed light Mx3 is secured, and the optical power of the OSC light Lo3 is increased. Further, since the tilt occurs in the pseudo light Pw1 in the optical transmission line T14, the pseudo light Pw1 branched from the multiplexed light Mx3 by the optical transceiver 200 is input to the optical amplifier 204 in a flat state in which the tilt is improved, as shown in FIG. 5B. Therefore, even if the optical amplifier 204 amplifies the pseudo light Pw1 without executing the tilt control, the optical power of the pseudo light Pw1 is maintained in the flat state.

As described above, according to the first embodiment, at the time of OSC link-up for establishing communication between the optical transmission device 300 and the optical transceiver 200 based on the OSC light and the pseudo light Pw1, the controller 310 calculates the transmission line tilt amount generated in the pseudo light Pw1 in the optical transmission line T14. The circuit board 342 of the optical amplifier 304 controls the output of the pseudo light Pw1 based on the transmission line tilt amount. Thus, the optical transmission device 300 can reduce the amount of transmission line tilt of the pseudo light Pw1. The optical transceiver 200 may be another optical transmission device that faces the optical transmission device 300. Similarly, for example, the optical transceiver 100 may be another optical transmission device facing the optical transmission device 400.

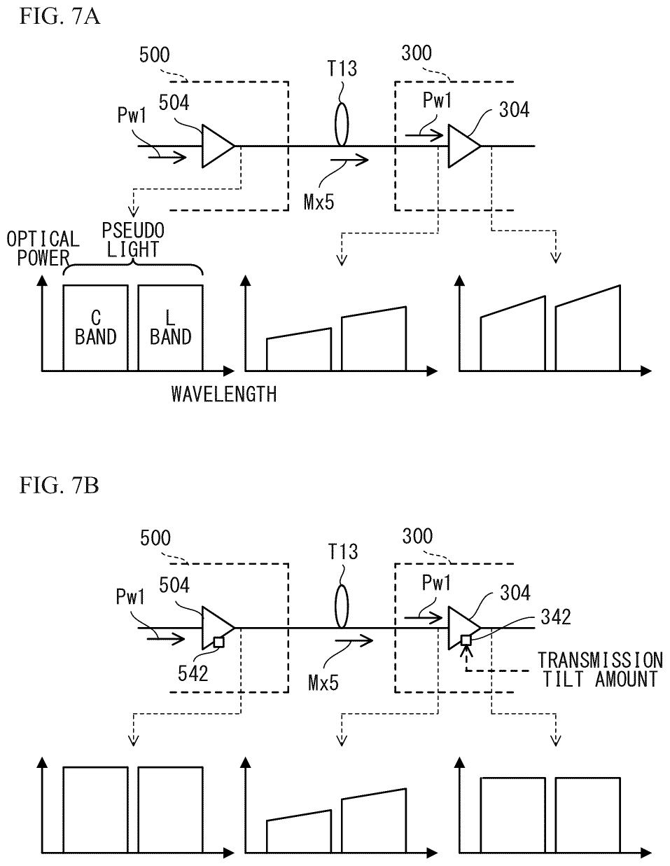

(Second Embodiment) Referring to FIGS. 7A and 7B, a second embodiment will be described in comparison with a comparative example related to the second embodiment. In the second embodiment, the optical transmission device 300 is described as an example of an optical transmission device, and the optical transmission device 500 is described as an example of another optical transmission device.

First, in the case of the comparative example in which the tilt control is not executed, as shown in FIG. 7A, an optical amplifier 504 can output the pseudo light Pw1 having a flat optical power without tilt. Thus, the multiplexed light Mx5 including the pseudo light Pw1 is output from the optical transmission device 500 and propagates through the optical transmission line T13.

However, the pseudo light Pw1 is tilted when propagating through the optical transmission line T13. Thus, the pseudo light Pw1 branched from the multiplexed light Mx5 by the optical transmission device 300 is input to the optical amplifier 304 in a state where the tilt remains. Therefore, even if the pseudo light Pw1 is amplified by the optical amplifier 304, the tilt remains in the pseudo light Pw1.

In contrast, in the case of the embodiment in which the tilt control is executed, the optical amplifier 504 can output the pseudo light Pw1 as shown in FIG. 7B. Therefore, the multiplexed light Mx5 including the pseudo light Pw1 is output from the optical transmission device 500 and propagates through the optical transmission line T13.

Since the pseudo light Pw1 is tilted when propagating through the optical transmission line T13, the pseudo light Pw1 branched from the multiplexed light Mx5 by the optical transmission device 300 is input to the optical amplifier 304 in a state where the tilt remains. Here, the circuit board 342 of the optical amplifier 304 is requested to perform the tilt control by the controller 310. Therefore, the optical amplifier 304 applies the reverse tilt based on the transmission line tilt amount to the pseudo light Pw1. The controller 310 can calculate the tilt amount of the transmission line tilt that occurs in the pseudo light Pw1 in the optical transmission line T13 that is the receiver side of the optical transmission device 300. Therefore, when the pseudo light Pw1 is amplified by the optical amplifier 304, the tilt is cancelled by the reverse tilt, and the pseudo light Pw1 having flat optical power with the tilt suppressed is output from the optical amplifier 304. In the first embodiment, the transmission line tilt is compensated in advance, but in this way, according to the second embodiment, the transmission line tilt of the pseudo light Pw1 can be compensated after the fact.

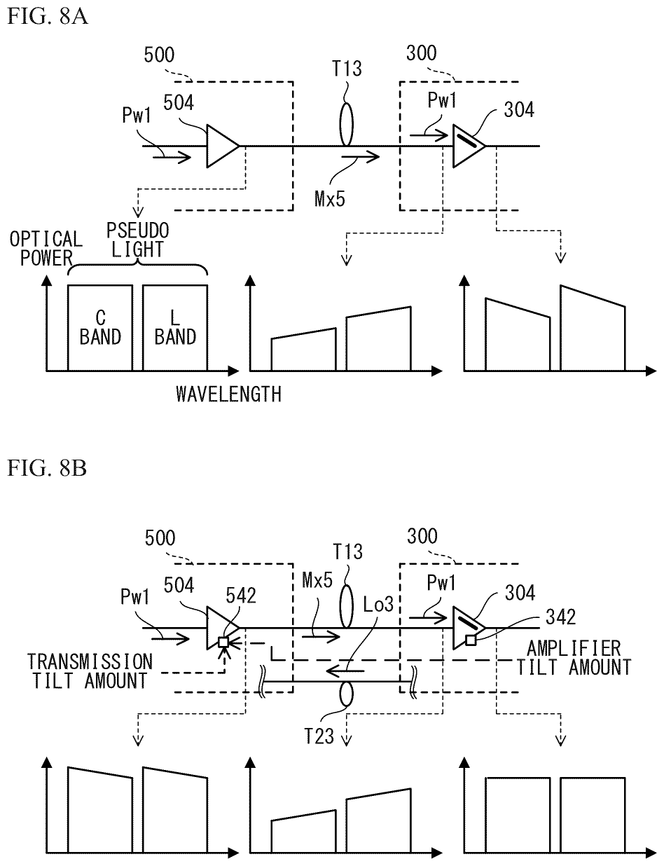

(Third Embodiment) Referring to FIGS. 8A and 8B, a third embodiment will be described in comparison with a comparative example related to the third embodiment. In the third embodiment, the optical transmission device 500 is described as an example of the optical transmission device, and the optical transmission device 300 is described as another example of the optical transmission device.

First, in the case of the comparative example in which the tilt control is not executed, as shown in FIG. 8A, the optical amplifier 504 can output the pseudo light Pw1 having a flat optical power without tilt. Thus, the multiplexed light Mx5 including the pseudo light Pw1 is output from the optical transmission device 500 and propagates through the optical transmission line T13. However, when the pseudo light Pw1 propagates through the optical transmission line T13, a tilt occurs in the pseudo light Pw1.

Thus, the pseudo light Pw1 branched from the multiplexed light Mx5 by the optical transmission device 300 is input to the optical amplifier 304 in a state where the tilt remains. When the input power of the pseudo light Pw1 to the optical amplifier 304 is small, the optical amplifier 304 may have a higher tilt on the short wavelength side than that on the long wavelength side. Therefore, when the pseudo light Pw1 is amplified by the optical amplifier 304, there is a possibility that the pseudo light Pw1 having a higher tilt on the short wavelength side than that on the long wavelength side is output from the optical amplifier 304.

In contrast, in the case of the embodiment in which tilt control is executed, as shown in FIG. 8B, in the optical amplifier 504, a reverse tilt based on the transmission line tilt amount and an amplifier tilt amount is given to the pseudo light Pw1 by a circuit board 542 provided in the optical amplifier 504. The circuit board 542 is an example of the controller, and the amplifier tilt amount is an example of a third tilt amount. The amplifier tilt amount is calculated by the controller 310. For example, the controller 310 can calculate the amplifier tilt amount of the optical amplifier 304 provided downstream of the optical amplifier 304 based on the input power of the pseudo light Pw1 estimated based on the gain of stimulated Raman scattering to the optical amplifier 504, a typical set value of the amplifier tilt generated due to noise, fluctuation, or the like of the optical amplifier 304, and a known third calculation formula designated in advance.

When the controller 310 calculates the amount of the amplifier tilt, the controller 110 requests the OSC input/output unit 302 to output the OSC light Lo3 including the amount of the amplifier tilt. Thus, the OSC input/output unit 302 can output the OSC light Lo3 directed to the optical transmission device 500. The OSC light Lo3 is output from the optical transmission device 300, and is input to the optical transmission device 500 via the optical transmission line T23. The circuit board 542 of the optical amplifier 504 adds the amplifier tilt amount and the transmission line tilt amount included in the OSC light Lo3 and applies the reverse tilt corresponding to the addition result to the pseudo light Pw1.

Thus, the pseudo light Pw1 to which the reverse tilt based on the transmission line tilt amount and the amplifier tilt amount is given is output from the optical amplifier 504. The multiplexed light Mx5 including the pseudo light Pw1 is output from the optical transmission device 500 and propagates through the optical transmission line T13. Here, when propagating through the optical transmission line T13, there is a case where the pseudo light Pw1 having a small optical power, in which the long wavelength side is higher than the short wavelength side, is input to the optical amplifier 304 due to the occurrence of a tilt in the pseudo light Pw1. However, in the optical amplifier 304, since a tilt higher on the short wavelength side than that on the long wavelength side occurs, the optical power of the pseudo light Pw1 is canceled by the optical amplifier 304. Thus, the optical amplifier 304 can output the pseudo light Pw1 having the flat optical power with the tilt suppressed.

As described above, in the first and second embodiments, the compensation for the transmission line tilt has been described, but according to the third embodiment, not only the transmission line tilt but also the amplifier tilt can be compensated in advance.

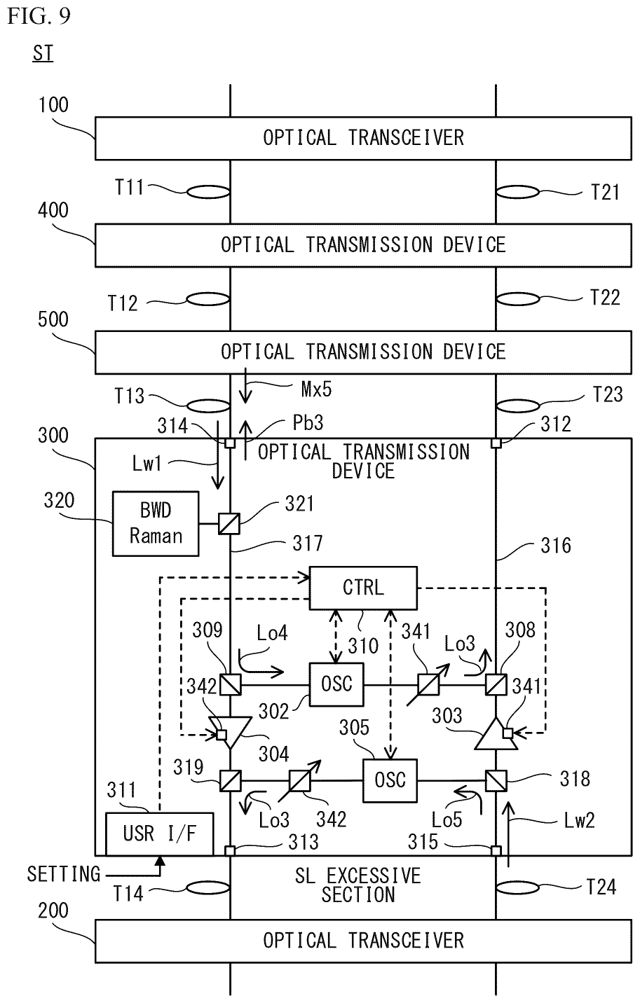

(Fourth Embodiment) A fourth embodiment of the present invention will be described with reference to FIGS. 9 to 11. The same components and processes as those of the optical transmission device 300 described in the first embodiment are denoted by the same reference numerals, and a detailed description thereof will be omitted. Since the optical transmission devices 400 and 500 have the same configuration and processing as those of the optical transmission device 300, a detailed description thereof will be omitted.

First, as shown in FIG. 9, the optical transmission device 300 includes a backward pumping Raman amplifier (denoted as BWD Raman in FIG. 9) 320. The backward pumping Raman amplifier 320 is an example of a backward pumping light source. The backward pumping Raman amplifier 320 is connected to the optical path 317 via a WDM coupler 321.

The backward pumping Raman amplifier 320 outputs a backward pumping light Pb3. The backward pumping light Pb3 propagates in the optical transmission line T13 in the direction opposite to the direction in which the WDM signal light Lw1 propagates in the optical transmission line T13. The backward pumping light Pb3 Raman-amplifies the multiplexed light Mx5 output from the optical transmission device 500 by using stimulated Raman scattering in the optical transmission line T13. Thus, the optical power of the OSC light Lo5 belonging to the multiplexed light Mx5 is further increased as compared with the case where the pseudo light Pw1 is used alone.

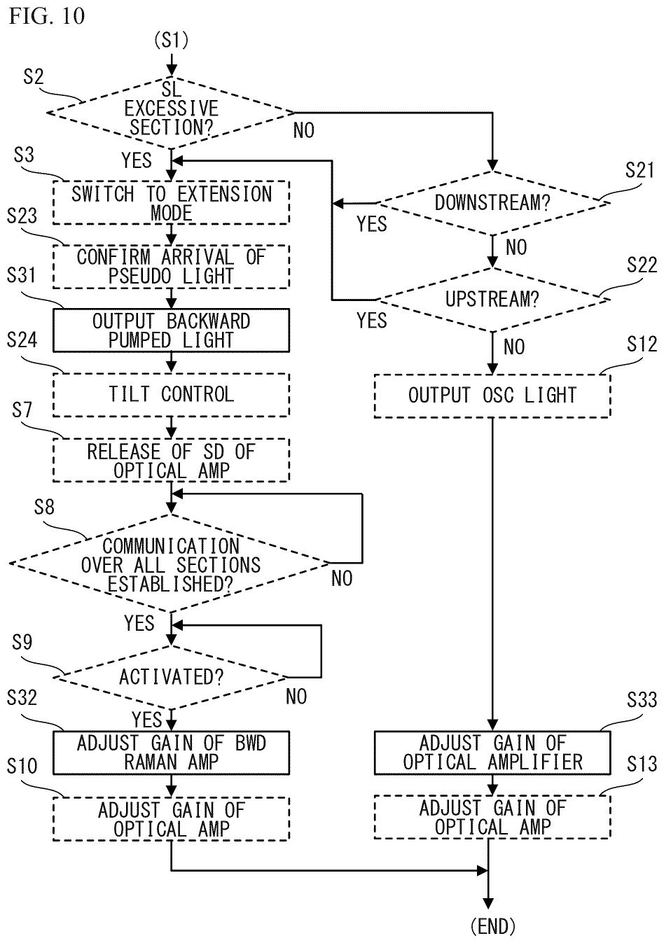

Referring to FIG. 10, the operation of the optical transmission device 300 according to the fourth embodiment will be described. The operations of the optical transmission devices 400 and 500 according to the fourth embodiment are basically similar to that of the optical transmission device 300 according to the fourth embodiment, and therefore, a detailed description thereof will be omitted. The same operation as that of the optical transmission device 300 described above is basically denoted by the same reference numeral, and a detailed description thereof will be omitted.

After the processing of step S23 described in the first embodiment and before the processing of step S24, the controller 310 instructs the backward pumping Raman amplifier 320 to output the backward pumping light Pb3 (step S31). Thus, the backward pumping Raman amplifier 320 outputs the backward pumping light Pb3.

The controller 310 adjusts the gain of the backward pumping Raman amplifier 320 after the processing of step S9 and before the processing of step S10 (step S32). After the gain of the backward pumping Raman amplifier 320 is adjusted, the controller 310 executes the subsequent processing and ends the processing. Further, the controller 310 adjusts the gain of the backward pumping Raman amplifier 320 after the processing of step S12 and before the processing of step S13 (step S33). After the gain of the backward pumping Raman amplifier 320 is adjusted, the controller 310 executes the subsequent processing and ends the processing.

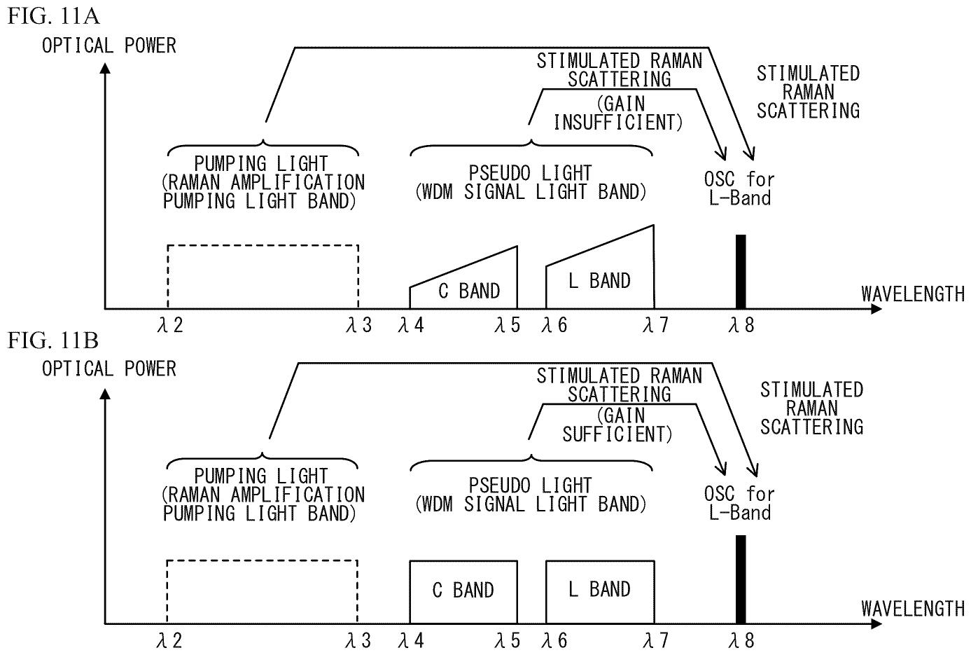

Thus, according to the fourth embodiment, the optical transmission device 300 includes the backward pumping Raman amplifier 320. Thus, the optical power of the OSC light Lo5 included in the multiplexed light Mx5 is further increased as compared with the case where the pseudo light Pw1 is used alone. Further, as shown in FIG. 11A, when the gain from the pseudo light Pw1 with respect to the OSC light Lo5 included in the multiplexed light Mx5 becomes insufficient due to the occurrence of tilt, it becomes difficult to increase the optical power of the OSC light Lo5. In contrast, as shown in FIG. 11B, the OSC light Lo5 can enjoy not only the effect of stimulated Raman scattering from the pseudo light Pw1 but also the effect of stimulated Raman scattering from the backward pumping light Pb3 including the wavelength band from the lowest wavelength 22 to the longest wavelength 23.

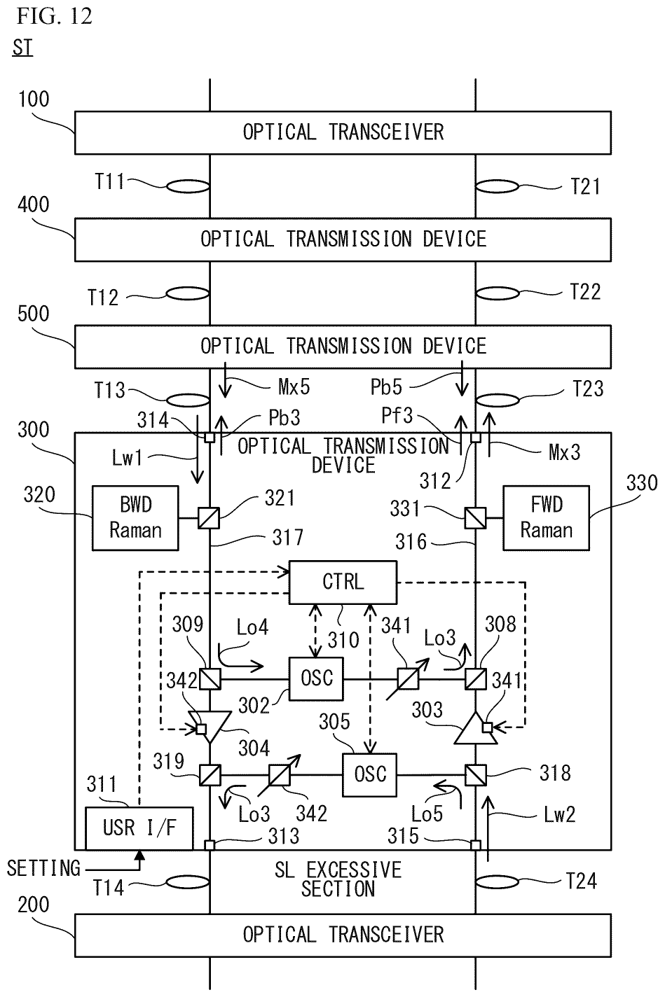

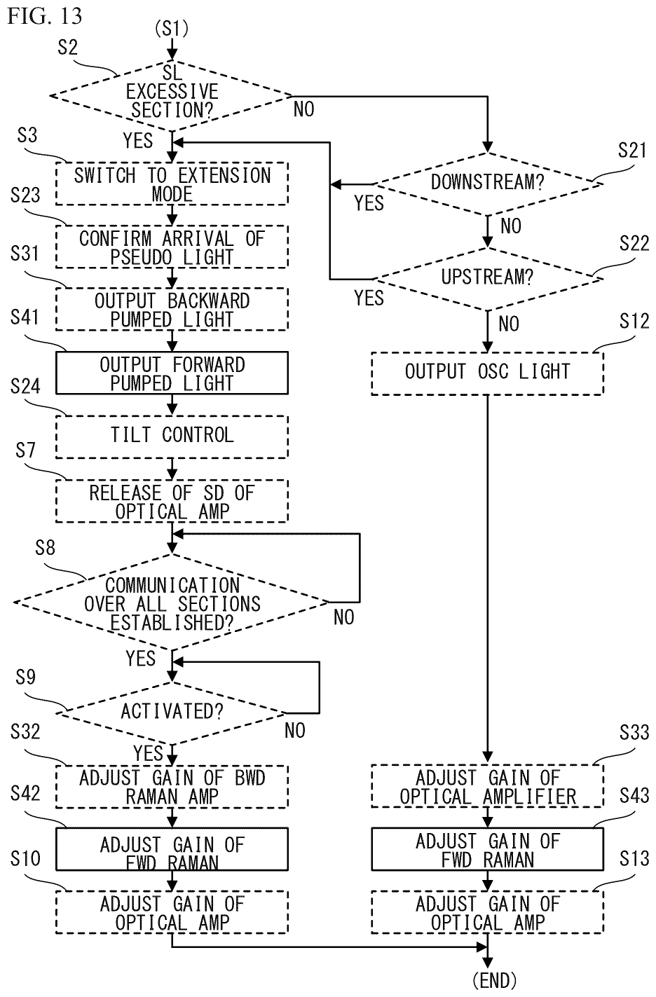

(Fifth Embodiment) Referring to FIGS. 12 and 13, a fifth embodiment of the present invention will be described. The same components and processes as those of the optical transmission device 300 described in the fourth embodiment are denoted by the same reference numerals, and a detailed description thereof will be omitted. The optical transmission devices 400 and 500 have configurations similar to the configuration of the optical transmission device 300, and therefore, a detailed description thereof is omitted.

First, as shown in FIG. 12, the optical transmission device 300 includes a forward pumping Raman amplifier (denoted as FWD Raman in FIG. 12) 330. The forward pumping Raman amplifier 330 is an example of a forward pumping light source. The forward pumping Raman amplifier 330 is connected to the optical path 316 via a WDM coupler 331.

The forward pumping Raman amplifier 330 outputs forward pumping light Pf3. The forward pumping light Pf3 propagates in the optical transmission line T23 in the same direction as the direction in which the WDM signal light Lw2 propagates in the optical transmission line T23. The forward pumping light Pf3 Raman-amplifies the multiplexed light Mx3 output from the optical transmission device 300 by using stimulated Raman scattering in the optical transmission line T23. Thus, the optical power of the OSC light Lo3 belonging to the multiplexed light Mx3 is further increased compared with the case where the pseudo light Pw2 output from the optical transceiver 200 and the backward pumping light Pb5 output from the optical transmission device 500 are used together.

Referring to FIG. 13, the operation of the optical transmission device 300 according to the fifth embodiment will be described. The operations of the optical transmission devices 400 and 500 according to the fifth embodiment are basically similar to that of the optical transmission devices 300 according to the fifth embodiment, and therefore, a detailed description thereof will be omitted. The same operation as that of the optical transmission device 300 described above is basically denoted by the same reference numeral, and a detailed description thereof will be omitted.

After the processing of step S31 described in the fourth embodiment and before the processing of step S24, the controller 310 instructs the forward pumping Raman amplifier 330 to output the forward pumping light Pf3 (step S41). Thus, the forward pumping Raman amplifier 330 outputs the forward pumping light Pf3.

The controller 310 adjusts the gain of the forward pumping Raman amplifier 330 after the processing of step S32 and before the processing of step S10 (step S42). After the gain of the forward pumping Raman amplifier 330 is adjusted, the controller 310 executes the subsequent processing and ends the processing. Further, the controller 310 adjusts the gain of the forward pumping Raman amplifier 330 after the processing of step S33 and before the processing of step S13 (step S43). After the gain of the forward pumping Raman amplifier 330 is adjusted, the controller 310 executes the subsequent processing and ends the processing.

Thus, according to the fifth embodiment, the optical transmission device 300 includes the forward pumping Raman amplifier 330. Thus, the optical power of the OSC light Lo3 included in the multiplexed light Mx3 is further increased compared with the case where the pseudo light Pw2 and the backward pumping light Pb5 are used in combination.

Although the embodiments have been described above in detail, the present disclosure is not limited to the specific embodiments, and various modifications and changes are possible within the scope of the disclosure.

For example, the controller 310 may determine a constant optical power to be used for outputting the pseudo light Pw1 based on not only the type of the optical transmission line T14 but also the configuration of the Raman amplifier, such as the sole use of the backward pumping Raman amplifier 320, the sole use of the forward pumping Raman amplifier 330, or the combined use of the backward pumping Raman amplifier 320 and the forward pumping Raman amplifier 330.

The controller of the optical transmission devices 500 may calculate the tilt amount of the amplifier tilt generated in the optical amplifier 504 (see FIG. 8B) based on the input power of the pseudo light Pw1 estimated based on the gain of stimulated Raman scattering to the optical amplifier 504, a typical set value of the amplifier tilt of the optical amplifier 504, and a known fourth calculation formula designated in advance. When the optical amplifier 504 cannot be controlled based on the tilt amount of the amplifier tilt, the controller of the optical transmission device 500 may transmit the OSC light Lo5 including an instruction to control the output of the pseudo light Pw1 based on the tilt amount of the amplifier tilt to the optical transmission device 300.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical transmission device comprising:
a light output unit that outputs OSC (Optical Supervisory Channel) light;
a calculator that calculates a tilt amount of a tilt occurring in a pseudo light in an optical transmission line connecting the optical transmission device and another optical transmission device facing the optical transmission device when establishing communication between the optical transmission device and the another optical transmission device based on the OSC light and the pseudo light including a wavelength band of a signal light repeated by the optical transmission device; and
a controller that controls output of the pseudo light based on the tilt amount.

2. The optical transmission device according to claim 1, wherein
the calculator calculates the tilt amount generated in either a first optical transmission line connected to a transmitter side of the optical transmission device in the optical transmission line or a second optical transmission line connected to a receiver side of the optical transmission device in the optical transmission line.

3. The optical transmission device according to claim 1, wherein
the calculator determines a constant optical power to be used for outputting the pseudo light based on a type of the optical transmission line, and
the controller controls output power of the pseudo light to the constant optical power.

4. The optical transmission device according to claim 1, wherein
the tilt includes a first tilt generated in the pseudo light in the optical transmission line based on stimulated Raman scattering, and
the calculator calculates a first tilt amount of the first tilt based on any of a type of the optical transmission line, an output power for outputting the pseudo light to the optical transmission line, a loss coefficient according to the type of the optical transmission line, and a connection loss between the optical transmission line and the optical transmission device.

5. The optical transmission device according to claim 1, wherein
the tilt includes a second tilt generated in the pseudo light in the optical transmission line based on a wavelength dependent loss, and
the calculator calculates a distance of the optical transmission line based on a transmission line loss of the optical transmission line and a loss coefficient corresponding to a type of the optical transmission line, and calculates a second tilt amount of the second tilt based on one of the distance and a loss value per unit distance of the wavelength dependent loss.

6. The optical transmission device according to claim 1, wherein
one of the optical transmission device and the another optical transmission device includes a downstream optical amplifier, and the other of the optical transmission device and the another optical transmission device includes an upstream optical amplifier, and
the calculator calculates a third tilt amount of an amplifier tilt generated in the downstream optical amplifier based on one of optical power of the pseudo light input to the downstream optical amplifier and a set value of the third tilt amount.

7. The optical transmission device according to claim 1, wherein
one of the optical transmission device and the another optical transmission device includes a downstream optical amplifier, and the other of the optical transmission device and the another optical transmission device includes an upstream optical amplifier, and
the calculator calculates a fourth tilt amount of an amplifier tilt generated in the upstream optical amplifier based on either optical power of the pseudo light inputted to the upstream optical amplifier or a set value of the fourth tilt amount, and transmits the OSC light including an instruction to control the output of the pseudo light based on the fourth tilt amount to one of the optical transmission device and the another optical transmission device.

8. The optical transmission device according to claim 1, further comprising a backward pumping light source that outputs, to the optical transmission line, backward pumping light propagating in a second direction opposite to a first direction in which the OSC light propagates in the optical transmission line,
the calculator instructing the backward pumping light source to output the backward pumping light.

9. The optical transmission device according to claim 1, further comprising a forward pumping light source that outputs, to the optical transmission line, forward pumping light propagating in a first direction in which the OSC light propagates through the optical transmission line,
the calculator instructing the forward pumping light source to output the forward pumping light.

10. The optical transmission device according to claim 1, wherein a wavelength of the OSC light is longer than a wavelength of the signal light.

11. The optical transmission device according to claim 1, wherein a wavelength of the OSC light is longer than a wavelength of the pseudo light.

12. An optical transmission system comprising
a first optical transmission device and a second optical transmission device which are opposed to each other through an optical transmission line and both repeat signal light, wherein at least one of the first optical transmission device and the second optical transmission device includes:
a light output unit that output OSC (Optical Supervisory Channel) light;
a calculator that calculates a tilt amount of a tilt occurring in a pseudo light in an optical transmission line connecting the first optical transmission device and the second optical transmission device when establishing communication between the first optical transmission device and the second optical transmission device based on the OSC light and the pseudo light including a wavelength band of the signal light; and
a controller that controls output of the pseudo light based on the tilt amount.
